(19) United States
(12) Patent Application Publication
(10) Pub. No.: US 2024/0377605 A1
(43) Pub. Date: Nov. 14, 2024

(54) OPTICAL SYSTEM AND ADJUSTING DEVICE THEREOF

(71) Applicants: Sintai Optical (Shenzhen) Co., Ltd., ShenZhen City (CN); Asia Optical Co., Inc., Taichung (TW)

(72) Inventors: Jiang-Lin Liu, ShenZhen City (CN); Hua-Tang Liu, Taichung (TW); Sheng Luo, ShenZhen City (CN); Jun-Wei Che, ShenZhen City (CN); Lian Zhao, ShenZhen City (CN)

(21) Appl. No.: 18/646,876

(22) Filed: Apr. 26, 2024

(30) Foreign Application Priority Data
May 11, 2023 (CN) 202310532319.8

(51) Int. Cl. G02B 7/00

(52) U.S. Cl. CPC G02B 7/004

(57) ABSTRACT

An optical system and the adjusting device thereof. The optical system includes an optical device. The adjusting device is configured for adjusting a location of a center of the optical device. The adjusting device includes a first adjusting element which is movable along a first axis and is propped against the optical device, a second adjusting element which is movable along a second axis and is propped against the optical device, and a third adjusting element which is movable along a third axis and is propped against the optical device. The center of the optical device is spaced apart from where the first axis and the second axis meet and/or where the first axis and the third axis meet.

### BACKGROUND OF THE INVENTION

### Field of the Invention

The invention relates to an optical system and the adjusting device thereof.

### Description of the Related Art

Generally, an optical system has plural optical elements, and a part of or all of the optical elements are required to be arranged coaxially. The coaxial requirement can be met by adjustment of the locations of the optical elements. Therefore, adjustment of the locations of the optical elements to meet the coaxial requirement thereby promoting the yield rate of products is a significant subject.

### BRIEF SUMMARY OF THE INVENTION

An object of the invention is to provide an optical device that utilizes an adjusting device to adjust a location of an optical element thereof. The invention has merits of simple adjustment operation, large adjustment range, an increased yield rate of products, and reduced manufacturing cost.

The adjusting device for adjusting a location of a center of an optical device in accordance with an exemplary embodiment of the invention includes a first adjusting element, a second adjusting element and a third adjusting element. The first adjusting element is movable along a first axis and is propped against the optical device. The second adjusting element is movable along a second axis and is propped against the optical device. The third adjusting element is movable along a third axis and is propped against the optical device. The first axis passes through the center of the optical device. The center of the optical device is spaced apart from where the first axis and the second axis meet. The second axis and the third axis are coaxial or are not coaxial.

In another exemplary embodiment, the first axis is a horizontal line. The center of the optical device is disposed apart from the second axis which is a vertical line. The second adjusting element and the third adjusting element are movable in same direction or in opposite directions.

The invention also provides an optical system. The optical system in accordance with an exemplary embodiment of the invention includes a plurality of optical elements, the above-mentioned adjusting device and the above-mentioned optical device. The optical elements include an optical axis. The first adjusting element, the second adjusting element and the third adjusting element are respectively moved along the first axis, the second axis and the third axis, so that the optical device and the optical elements can be coaxial.

In another exemplary embodiment, the optical device includes a transmissive display and a supporting frame supporting the transmissive display. The first adjusting element, the second adjusting element and the third adjusting element are propped against the supporting frame to adjust the location of the center of the optical device. The supporting frame includes an arc surface against which the first adjusting element is propped. A third tangent plane is tangent to the arc surface and the first adjusting element. The third tangent plane and the first axis have a first included angle which is about ninety degrees.

In yet another exemplary embodiment, the supporting frame further includes a first cylindrical element and a second cylindrical element, central axes of the first cylindrical element and the second cylindrical element are parallel to the optical axis, and the second adjusting element and the third adjusting element are respectively propped against the first cylindrical element and the second cylindrical element.

In another exemplary embodiment, the first cylindrical element and the second cylindrical element are pins, and the second adjusting element and the third adjusting element are adjustment screws.

In yet another exemplary embodiment, a first tangent plane is tangent to the first cylindrical element and the second adjusting element. A second tangent plane is tangent to the second cylindrical element and the third adjusting element. The first adjusting element, the second adjusting element and the third adjusting element are respectively moved along the first axis, the second axis and the third axis, so that normal lines of the first tangent plane and the second tangent plane intersect the first axis at the center of the optical device.

In another exemplary embodiment, the first tangent plane and the second axis have a second included angle which is not equal to ninety degrees, and the second tangent plane and the third axis have a third included angle which is not equal to ninety degrees.

In yet another exemplary embodiment, the optical elements include an objective lens group and an eyepiece group, the optical device includes a transmissive display, and the objective lens group, the transmissive display and the eyepiece group are sequentially arranged along the optical axis. An intersection of the first axis and the second axis is disposed within the transmissive display. Another intersection of the first axis and the third axis is also disposed within the transmissive display.

In another exemplary embodiment, the adjusting device includes a first adjusting element, a second adjusting element and a third adjusting element. The first adjusting element is movable along a first axis and is propped against the optical device. The second adjusting element is movable along a second axis and is propped against the optical device. The third adjusting element is movable along a third axis and is propped against the optical device. The first axis passes through the center of the optical device. The center of the optical device is spaced apart from where the first axis and the second axis meet and/or where the first axis and the third axis meet.

In yet another exemplary embodiment, the first axis is a horizontal line. The center of the optical device is disposed apart from the second axis which is a vertical line. The second adjusting element and the third adjusting element are movable in same direction or in opposite directions.

In another exemplary embodiment, the second axis and the third axis coincide. The center of the optical device is disposed apart from the second axis and the third axis. The second axis and the third axis are vertical lines.

In yet another exemplary embodiment, the optical system includes a plurality of optical elements, the above-mentioned adjusting device and the above-mentioned optical device. The optical elements include an optical axis. The first adjusting element, the second adjusting element and the third adjusting element are respectively moved along the first axis, the second axis and the third axis, so that the optical device and the optical elements can be coaxial.

In another exemplary embodiment, the optical device includes a transmissive display and a supporting frame supporting the transmissive display. The first adjusting element, the second adjusting element and the third adjusting element are propped against the supporting frame to adjust the location of the center of the optical device. The supporting frame includes an arc surface against which the first adjusting element is propped. A third tangent plane is tangent to the arc surface and the first adjusting element. The third tangent plane and the first axis have a first included angle which is about ninety degrees.

In yet another exemplary embodiment, the supporting frame further includes a first cylindrical element and a second cylindrical element, central axes of the first cylindrical element and the second cylindrical element are parallel to the optical axis, and the second adjusting element and the third adjusting element are respectively propped against the first cylindrical element and the second cylindrical element.

In another exemplary embodiment, the first cylindrical element and the second cylindrical element are pins, and the second adjusting element and the third adjusting element are adjustment screws.

In yet another exemplary embodiment, a first tangent plane is tangent to the first cylindrical element and the second adjusting element. A second tangent plane is tangent to the second cylindrical element and the third adjusting element. The first adjusting element, the second adjusting element and the third adjusting element are respectively moved along the first axis, the second axis and the third axis, so that normal lines of the first tangent plane and the second tangent plane intersect the first axis at the center of the optical device.

In another exemplary embodiment, the first tangent plane and the second axis have a second included angle which is not equal to ninety degrees, and the second tangent plane and the third axis have a third included angle which is not equal to ninety degrees.

In yet another exemplary embodiment, the optical elements include an objective lens group and an eyepiece group, the optical device includes a transmissive display, and the objective lens group, the transmissive display and the eyepiece group are sequentially arranged along the optical axis. An intersection of the first axis and the second axis is disposed within the transmissive display. Another intersection of the first axis and the third axis is also disposed within the transmissive display.

### BRIEF DESCRIPTION OF THE DRAWINGS

FIG. 1 is a schematic view showing the structure of an optical system in accordance with an embodiment of the invention.

FIG. 2 is a sectional view of an optical device in accordance with an embodiment of the invention.

FIG. 3 shows the geometric relationship of the optical device and an adjusting device of FIG. 2.

### DETAILED DESCRIPTION OF THE INVENTION

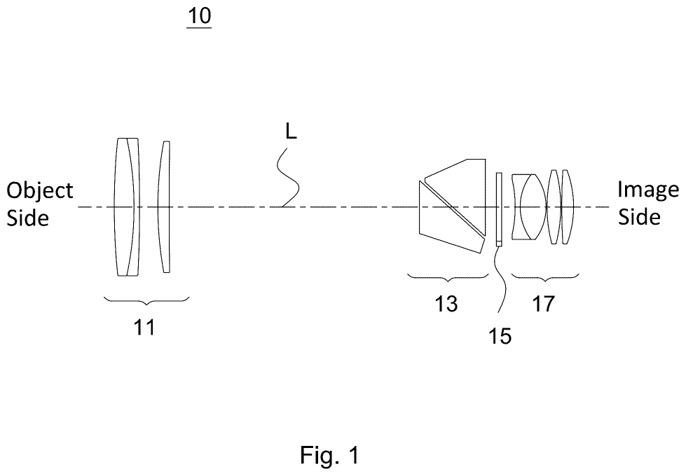

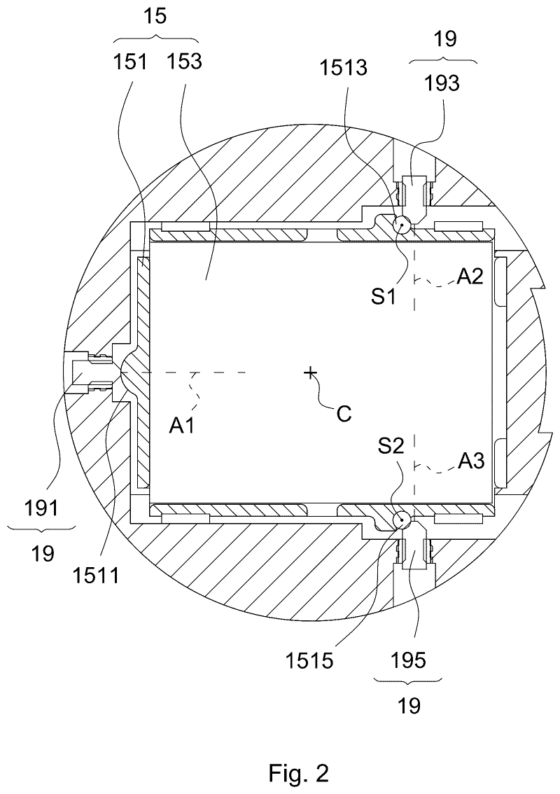

Referring to FIG. 1, FIG. 1 is a schematic view showing the structure of an optical system in accordance with an embodiment of the invention. In this embodiment, the optical system 10 is a rangefinder monocular or rangefinder binoculars that include a plurality of optical elements, for example, an object lens group 11, a prism module 13, an optical device 15, an eyepiece group 17 and so on. These optical elements are arranged along an optical axis L from an object side to an image side. Further referring to FIG. 2, the optical device 15 includes a transmissive display 153 and a supporting frame 151 for supporting the transmissive display 153.

In operation of the optical system 10, ambient light from the object side sequentially passes through the object lens group 11, the prism module 13, the transmissive display 153 and the eyepiece group 17 and reaches user's eye. Therefore, the user is able to observe a target object (not shown). Distance measuring light is emitted by a light emitter (not shown), passes through the prism module 13 and the object lens group 11, and reaches the target object. Then, the distance measuring light is reflected by the target object (not shown), passes through the object lens group 13 and the eyepiece group 17, and is received by a light receiver (not shown). The distance of the target object (not shown) can be calculated by using the interval between the light emitting time and the light receiving time and is shown by the transmissive display 153 for user's reference.

It is worth noting that the optical system of the invention is not limited to what is shown in FIG. 1. In some embodiments, the prism module 13 is omitted.

Due to the manufacturing tolerance or some other factors, the central axis of the optical device 15 may not coincide with the optical axis L. The invention therefore provides an adjusting device 19, as shown in FIG. 2, for adjusting the location of the optical device 15 so that the central axis of the optical device 15 can coincide with the optical axis L, namely the optical device 15, the objective lens group 11, the prism module 13 and the eyepiece group 17 can become coaxial. The yield rate and the quality of the optical system 10 are therefore promoted. The structure of the invention is described in detail in the following:

The adjusting device 19 includes a first adjusting element 191, a second adjusting element 193 and a third adjusting element 195. In this embodiment, the first adjusting element 191, the second adjusting element 193 and the third adjusting element 195 are adjustment screws.

The supporting frame 151 of the optical device 15 is provided with a protrusion on one side, and is provided with a first cylindrical element 1513 and a second cylindrical element 1515 on two other opposite sides. The protrusion has an arc surface 1511. The central axes of the first cylindrical element 1513 and the second cylindrical element 1515 are parallel to the optical axis L. In this embodiment, the first cylindrical element 1513 and the second cylindrical element 1515 are pins.

The first adjusting element 191, the second adjusting element 193 and the third adjusting element 195 are propped against the arc surface 1511, the first cylindrical element 1513 and the second cylindrical element 1515, respectively. In adjusting operation, the first adjusting element 191 can be moved in opposite directions along a first axis A1, the second adjusting element 193 can be moved in opposite directions along a second axis A2, and the third adjusting element 195 can be moved in opposite directions along a third axis A3. In other words, the second adjusting element 193 and the third adjusting element 195 can be moved in the same direction or in opposite directions to adjust the location of the center C of the optical device 15. As described, the first adjusting element 191, the second adjusting element 193 and the third adjusting element 195 are adjustment screws. In this embodiment, each adjustment screw is fitted in a screw hole, with the external threads of the adjustment screw mated with the internal threads of the screw hole. Therefore, when twisted, the adjustment screws can be moved forward or backward (i.e. in opposite directions) along the first axis A1, the second axis A2 and the third axis A3 by means of the thread structure to adjust the location of the center C of the optical device 15.

In this embodiment, the first axis A1 is a horizontal line, and the second axis A2 and the third axis A3 are vertical lines. The central axis S1 of the first cylindrical element 1513 is perpendicular to the second axis A2. The central axis S2 of the second cylindrical element 1515 is perpendicular to the third axis A3.

In this embodiment, the first axis A1 is configured to pass through the center C of the optical device 15, the second axis A2 and the third axis A3 are configured to coincide with each other, and the center C of the optical device 15 is disposed apart from the second axis A2 and the third axis A3. However, the invention is not limited thereto. For example, the second axis A2 and the third axis A3 are disposed in parallel and do not coincide with each other. The location of the center C of the optical device 15 can be still adjusted, as long as the intersection of the first axis A1 and the second axis A2 is spaced apart from the center C of the optical device 15 and disposed within the transmissive display 153 and the intersection of the first axis A1 and the third axis A3 is also spaced apart from the center C of the optical device 15 and disposed within the transmissive display 153. It is understood that, when the second axis A2 and the third axis A3 coincide with each other, the location of the center C of the optical device 15 can be adjusted by moving the second adjusting element 193 proposed against the optical device 15 along the second axis A2 in a first direction and by moving the third adjusting element 195 proposed against the optical device 15 along the second axis A2 in a second direction, wherein the first direction and the second direction are oriented towards each other. Further, in the invention, the arrangement that the first axis A1 is configured to pass through the center C of the optical device 15 is not necessary for adjustment of the location of the center C of the optical device 15. However, adjustment of the location of the center C of the optical device 15 can be simplified when the first axis A1 is configured to pass through the center C of the optical device 15.

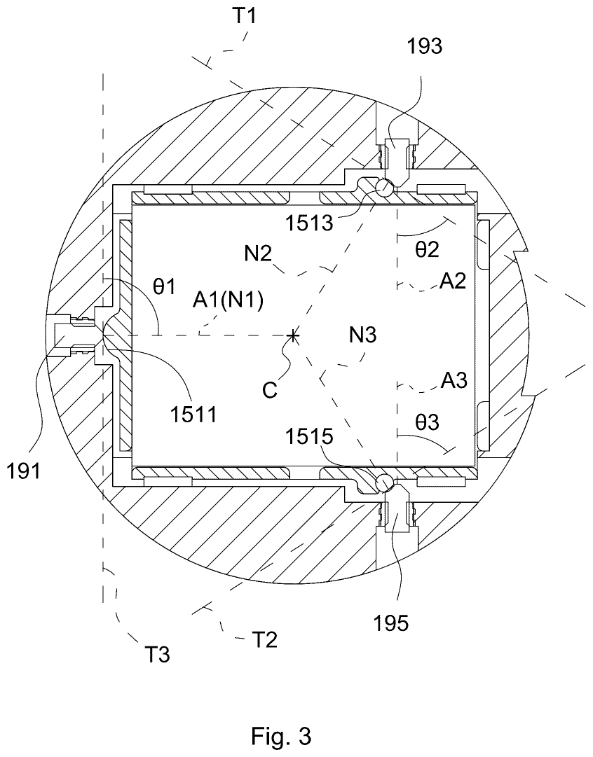

Referring to FIG. 3, FIG. 3 shows the geometric relationship of the optical device and the adjusting device of FIG. 2. As described, the first adjusting element 191 is propped against the arc surface 1511. Therefore, there is a third tangent plane T3 that is tangent to the arc surface 1511 and the first adjusting element 191. Similarly, the second adjusting element 193 is propped against the first cylindrical element 1513, and there is a first tangent plane T1 that is tangent to the second adjusting element 193 and the first cylindrical element 1513. The third adjusting element 195 is propped against the second cylindrical element 1515, and there is a second tangent plane T2 that is tangent to the third adjusting element 195 and the second cylindrical element 1515. During adjustment, the first adjusting element 191 is horizontally moved along the first axis A1, the second adjusting element 193 is vertically moved along the second axis A2, and the third adjusting element 195 is vertically moved along the third axis A3. It is worth noting that the contact point between the first adjusting element 191 and the arc surface 1511 is variable. Also, the contact point between the second adjusting element 193 and the first cylindrical element 1513 and the contact point between the third adjusting element 195 and the second cylindrical element 1515 are variable. The contact points vary depending from the location of the optical device 15, and the first tangent plane T1, the second tangent plane T2 and the third tangent plane T3 follow to vary. In this embodiment, the first tangent plane T1 and the second axis A2 have a second included angle θ2 therebetween, wherein the second included angle θ2 is not equal to ninety degrees. The second tangent plane T2 and the third axis A3 have a third included angle θ3 therebetween, and the third included angle θ3 is not equal to ninety degrees. The third tangent plane T3 and the first axis A1 have a first included angle θ1 therebetween and the first included angle θ1 is about ninety degrees.

During the adjustment, the second adjusting element 193 applies an action force N2 to the optical device 15 wherein the action force N2 is perpendicular to the first tangent plane T1. The third adjusting element 195 applies an action force N3 to the optical device 15 and the action force N3 is perpendicular to the second tangent plane T2. The first adjusting element 191 applies an action force N1 to the optical device 15 and the action force N1 is perpendicular to the third tangent plane T3. Under the action forces N1, N2 and N3, the optical device 15 is moved horizontally and vertically until the center C of the optical device 15 and the optical axis L coincide. When the center C of the optical device 15 and the optical axis L coincide, the action forces N1, N2 and N3 are directed to the center C of the optical device 15 and are in equilibrium, so that the center C of the optical device 15 can be kept stationary in the optical axis L. It is worth noting that the normal line of the first tangent plane T1, the normal line of the second tangent plane T2, and the first axis A1 intersect at the center C of the optical device 15 when the action forces N1, N2 and N3 are directed to the center C of the optical device 15 and are in equilibrium.

From the above descriptions, it is understood that the invention does not directly apply a vertical force to the optical device 15 to change the location of the optical device 15 in the vertical direction. Rather, the invention utilizes the second adjusting element 193 and the third adjusting element 195 to push against the first cylindrical element 1513 and the second cylindrical element 1515, thereby changing the directions of the action forces. Accordingly, the invention has merits of simple adjustment operation, large adjustment range, an increased yield rate, and reduced manufacturing cost.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An adjusting device for adjusting a location of a center of an optical device, comprising:
a first adjusting element which is movable along a first axis and is propped against the optical device;
a second adjusting element which is movable along a second axis and is propped against the optical device;
a third adjusting element which is movable along a third axis and is propped against the optical device;
wherein the first axis passes through the center of the optical device;
wherein the center of the optical device is spaced apart from where the first axis and the second axis meet;
wherein the second axis and the third axis are coaxial or are not coaxial.

2. The adjusting device as claimed in claim 1, wherein:
the first axis is a horizontal line;
the center of the optical device is disposed apart from the second axis which is a vertical line;
the second adjusting element and the third adjusting element are movable in same direction or in opposite directions.

3. An optical system, comprising:
a plurality of optical elements comprising an optical axis;
the adjusting device as claimed in claim 1;
the optical device as claimed in claim 1;
wherein the first adjusting element, the second adjusting element and the third adjusting element are respectively moved along the first axis, the second axis and the third axis, so that the optical device and the optical elements can be coaxial.

4. The optical system as claimed in claim 3, wherein:
the optical device comprises a transmissive display and a supporting frame supporting the transmissive display;
the first adjusting element, the second adjusting element and the third adjusting element are propped against the supporting frame to adjust the location of the center of the optical device;
the supporting frame comprises an arc surface against which the first adjusting element is propped;
a third tangent plane is tangent to the arc surface and the first adjusting element;
the third tangent plane and the first axis have a first included angle which is about ninety degrees.

5. The optical system as claimed in claim 4, wherein the supporting frame further comprises a first cylindrical element and a second cylindrical element, central axes of the first cylindrical element and the second cylindrical element are parallel to the optical axis, and the second adjusting element and the third adjusting element are respectively propped against the first cylindrical element and the second cylindrical element.

6. The optical system as claimed as claim 5, wherein the first cylindrical element and the second cylindrical element are pins, and the second adjusting element and the third adjusting element are adjustment screws.

7. The optical system as claimed in claim 5, wherein:
a first tangent plane is tangent to the first cylindrical element and the second adjusting element;
a second tangent plane is tangent to the second cylindrical element and the third adjusting element;
the first adjusting element, the second adjusting element and the third adjusting element are respectively moved along the first axis, the second axis and the third axis, so that normal lines of the first tangent plane and the second tangent plane intersect the first axis at the center of the optical device.

8. The optical system as claimed as claim 7, wherein the first tangent plane and the second axis have a second included angle which is not equal to ninety degrees, and the second tangent plane and the third axis have a third included angle which is not equal to ninety degrees.

9. The optical system as claimed as claim 3, wherein:
the optical elements comprise an objective lens group and an eyepiece group, the optical device comprises a transmissive display, and the objective lens group, the transmissive display and the eyepiece group are sequentially arranged along the optical axis;
an intersection of the first axis and the second axis is disposed within the transmissive display;
another intersection of the first axis and the third axis is also disposed within the transmissive display.

10. An adjusting device for adjusting a location of a center of an optical device, comprising:
a first adjusting element which is movable along a first axis and is propped against the optical device;
a second adjusting element which is movable along a second axis and is propped against the optical device;
a third adjusting element which is movable along a third axis and is propped against the optical device;
wherein the first axis passes through the center of the optical device;
wherein the center of the optical device is spaced apart from where the first axis and the second axis meet and/or where the first axis and the third axis meet.

11. The adjusting device as claimed in claim 10, wherein:
the first axis is a horizontal line;
the center of the optical device is disposed apart from the second axis which is a vertical line;
the second adjusting element and the third adjusting element are movable in same direction or in opposite directions.

12. The adjusting device as claimed in claim 10, wherein:
the second axis and the third axis coincide;
the center of the optical device is disposed apart from the second axis and the third axis;
the second axis and the third axis are vertical lines.

13. An optical system, comprising:
a plurality of optical elements comprising an optical axis;
the adjusting device as claimed in claim 10;
the optical device as claimed in claim 10;
wherein the first adjusting element, the second adjusting element and the third adjusting element are respectively moved along the first axis, the second axis and the third axis, so that the optical device and the optical elements can be coaxial.

14. The optical system as claimed in claim 13, wherein:
the optical device comprises a transmissive display and a supporting frame supporting the transmissive display;
the first adjusting element, the second adjusting element and the third adjusting element are propped against the supporting frame to adjust the location of the center of the optical device;
the supporting frame comprises an arc surface against which the first adjusting element is propped;
a third tangent plane is tangent to the arc surface and the first adjusting element;
the third tangent plane and the first axis have a first included angle which is about ninety degrees.

15. The optical system as claimed in claim 14, wherein the supporting frame further comprises a first cylindrical element and a second cylindrical element, central axes of the first cylindrical element and the second cylindrical element are parallel to the optical axis, and the second adjusting element and the third adjusting element are respectively propped against the first cylindrical element and the second cylindrical element.

16. The optical system as claimed as claim 15, wherein the first cylindrical element and the second cylindrical element are pins, and the second adjusting element and the third adjusting element are adjustment screws.

17. The optical system as claimed in claim 15, wherein:
a first tangent plane is tangent to the first cylindrical element and the second adjusting element;
a second tangent plane is tangent to the second cylindrical element and the third adjusting element;
the first adjusting element, the second adjusting element and the third adjusting element are respectively moved along the first axis, the second axis and the third axis, so that normal lines of the first tangent plane and the second tangent plane intersect the first axis at the center of the optical device.

18. The optical system as claimed as claim 17, wherein the first tangent plane and the second axis have a second included angle which is not equal to ninety degrees, and the second tangent plane and the third axis have a third included angle which is not equal to ninety degrees.

19. The optical system as claimed as claim 13, wherein:
the optical elements comprise an objective lens group and an eyepiece group, the optical device comprises a transmissive display, and the objective lens group, the transmissive display and the eyepiece group are sequentially arranged along the optical axis;
an intersection of the first axis and the second axis is disposed within the transmissive display;
another intersection of the first axis and the third axis is also disposed within the transmissive display.
